(19) United States
(12) Patent Application Publication
(10) Pub. No.: US 2009/0056873 A1
(43) Pub. Date: Mar. 5, 2009

(54) POLYURETHANE ADHESIVE COMPRISING SILANE GROUPS AND CARBODIIMIDE GROUPS

(75) Inventors: Karl-Heinz Schumacher, Neustadt (DE); Ulrike Licht, Mannheim (DE); Denise du Fresne von Hohenesche, Mannheim (DE); Andre Burghardt, Dickesbach (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/161,484

(22) PCT Filed: Jan. 11, 2007
(86) PCT No.: PCT/EP2007/050236

§ 371 Date: Jul. 18, 2008

(30) Foreign Application Priority Data
Jan. 19, 2006 (EP) 06100590.6

(51) Int. Cl. B32B 37/12; C08L 75/04

(52) U.S. Cl. 156/329; 525/454

(57) ABSTRACT

An adhesive comprising a polyurethane and 0.0001 to 0.1 mol of carbodiimide groups per 100 g of polyurethane, wherein the polyurethane contains 0.0001 to 0.1 mol of hydroxysilane or alkoxysilane groups (silane groups for short) per 100 g of polyurethane.

The invention relates to an adhesive comprising a polyurethane and 0.0001 to 0.1 mol of carbodiimide groups per 100 g of polyurethane, wherein the polyurethane contains 0.0001 to 0.1 mol of hydroxysilane or alkoxysilane groups (silane groups for short) per 100 g of polyurethane.

Aqueous polyurethane dispersions are used as adhesives, not least as laminating adhesives, in the automobile or furniture industry, for example.

For industrial lamination of this kind a high heat resistance is particularly important, and the bond ought also to retain its strength at high temperatures for as long a time as possible.

Polyurethanes containing carbodiimide groups or polyurethane dispersions comprising carbodiimide additives are known: see DE-A 100 00 656 or DE-A 100 01 777, for example. WO 2005/05565 describes the use of such polyurethanes for industrial lamination.

Polyurethanes containing alkoxysilane groups are described for example in EP-A 163 214 or EP-A 315 006; DE-A 42 15 648 relates to the use of polyurethanes containing alkoxy groups as a contact adhesive.

Carbodiimides containing silane groups are described in DE-A 10 2004 024 195 and DE-A 10 2004 024 196; those carbodiimides, however, are used not in adhesives but instead as stabilizers in plastics.

It was an object of the invention further to improve the performance properties of polyurethane dispersions for industrial lamination; in particular, the intention is that the heat resistance should be very good indeed.

Found accordingly has been the adhesive defined above.

The adhesive of the invention comprises a polyurethane containing 0.0001 to 0.1 mol of silane groups, preferably 0.0005 to 0.1 mol, more preferably 0.001 to 0.1 mol of silane groups per 100 g of polyurethane, in particular, the silane group content is not higher than 0.05 mol/100 g of polyurethane.

The silane groups comprise at least one hydroxyl group or alkoxy group. The groups in question are generally alkoxy groups; in the course of the subsequent use, the alkoxy groups are then hydrolyzed to hydroxyl groups, which then react further, or crosslink.

The silane groups are, in particular, groups of the formula I

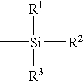

where at least one of the radicals R¹ to R³ is a hydroxyl group or alkoxy group and the remaining radicals are each an alkoxy group, hydroxyl group or alkyl group; the silane group is attached to the polyurethane via the bond which is still free in the above formula.

Preferably at least one, preferably two, and more preferably all three radicals R¹ to R³ are an alkoxy group.

The groups in question are, in particular, C1 to C9, more preferably C1 to C6, very preferably C1 to C3 alkoxy or alkyl groups. In particular the alkyl groups are each a methyl group and the alkoxy groups are each a methoxy group.

A particularly preferred alkoxysilane group carries 2 or 3 methoxy groups.

The silane group is attached to the polyurethane in particular as a result of reaction of synthesis components of the polyurethane with a compound comprising silane groups (silane compound for short below).

The silane compound is therefore a compound containing at least one isocyanate group or at least one isocyanate-reactive group, e.g., a primary or secondary amino group, a hydroxyl group or a mercapto group.

The silane compound may have been incorporated in the polyurethane as a chain extender or terminally at the chain end.

Silane compounds as chain extenders comprise at least two reactive groups (isocyanate group or isocyanate-reactive group) which are reacted with other synthesis components of the polyurethane and so advance the polyurethane chain and increase the molecular weight; in contrast to this, silane compounds with only one reactive group lead to chain termination in the reaction and are incorporated terminally.

With particular preference the silane compound is a chain extender.

Suitable silane compounds are in particular of low molecular weight and have a molecular weight below 5000, in particular below 2000, more preferably below 1000, and very preferably below 500 g/mol; the molar weight is generally above 50, in particular above 100, or 150 g/mol.

The reactive groups of the silane compound are preferably primary or secondary amino groups. With particular preference the alkoxysilane compound comprises two primary amino groups, two secondary amino groups or one primary and one secondary amino group.

Examples of suitable silane compounds include
H₂N—(CH₂)³—Si(OCH₃)³
H₂N—(CH₂)³—NH—(CH₂)³—Si(OCH₃)³,
H₂N—(CH₂)²—NH—(CH₂)²—Si(OCH₃)³,
H₂N—(CH₂)²—NH—(CH₂)³—Si(OCH₃)³,
H₂N—(CH₂)³—NH—(CH₂)²—Si(OCH₃)³

The composition further comprises carbodiimide groups

Carbodiimide groups have the general structural formula —N═C═N—.

Carbodiimide groups are obtainable in a simple way from two isocyanate groups, with elimination of carbon dioxide:

—R—N═C═O+O═C═N—R

—R—N═C═N—R—+CO₂

Starting from polyisocyanates or diisocyanates it is possible in this way to obtain compounds containing carbodiimide groups and, if appropriate, isocyanate groups, especially terminal isocyanate groups (the resulting compounds being referred to below for short as carbodiimide compounds).

Examples of suitable diisocyanates include diisocyanates X(NCO)₂, where X is an aliphatic hydrocarbon radical having 4 to 12 carbon atoms, a cycloaliphatic or aromatic hydrocarbon radical having 6 to 15 carbon atoms, or an araliphatic hydrocarbon radical having 7 to 15 carbon atoms. Examples of such diisocyanates include tetramethylene diisocyanate, hexamethylene diisocyanate, dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)-propane, trimethylhexane diisocyanate, 1,4-diisocyanatobenzene, 2,4-diisocyanatotoluene, 2,6-diisocyanatotoluene, 4,4′-diisocyanato-diphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI) such as the trans/trans, the cis/cis, and the cis/trans isomers, and mixtures of these compounds.

Particular preference is given to TMXDI.

As a result of the terminal isocyanate groups the carbodiimide compounds can easily be hydrophilically modified, by reaction with amino acids or hydroxy acids, for example. Hydrophilically modified carbodiimide compounds are of course easier to mix with aqueous adhesives or adhesives based on hydrophilic polymers.

With similar ease it is possible to attach the carbodiimide compounds to the polyurethane, by reacting the isocyanate group with a reactive group of the polymer, such as an amino group or hydroxyl group.

Suitable carbodiimide compounds comprise in general on average 1 to 20, preferably 1 to 15, more preferably 2 to 10 carbodiimide groups.

The number-average molar weight Mₙ is preferably 100 to 10 000, more preferably 200 to 5000, and very particularly 500 to 2000 g/mol.

The number-average molecular weight is determined by endgroup analysis of the diisocyanates (i.e., consumption of the isocyanate groups by carbodiimide formation; see below) or, if endgroup analysis is not possible, by gel permeation chromatography (polystyrene standard, THF as eluent).

The adhesive of the invention may therefore comprise carbodiimide compounds as an additive or in attached form as synthesis components of the polyurethane.

Preferably more than 50 mol %, in particular more than 80 mol %, more preferably more than 90 mol % of all the carbodiimide groups present in the composition are attached to the polyurethane, and in particular all of the carbodiimide groups are attached to the polyurethane.

With particular preference the polyurethanes is composed predominantly of polyisocyanates, especially diisocyanates, on the one hand, and, as co-reactants, polyesterdiols, polyetherdiols or mixtures thereof, on the other hand.

The polyurethane is preferably synthesized from at least 40%, more preferably at least 60%, and very preferably at least 80% by weight of diisocyanates, polyetherdiols and/or polyesterdiols.

For this purpose the polyurethane preferably comprises polyesterdiols in an amount of more than 10% by weight, based on the polyurethane.

The polyurethane preferably has a softening point or melting point in the range from −50 to 150° C., more preferably from 0 to 100° C., and with very particular preference from 10 to 90° C.

With particular preference the polyurethane has a melting point within the above temperature range.

The polyurethane is preferably a dispersion in water, and the adhesive thus constitutes therefore an aqueous polyurethane dispersion. In particular the polyurethane comprises anionic groups, especially carboxylate groups, in order to ensure its dispersibility in water.

Overall the polyurethane is preferably synthesized from
a) diisocyanates,
b) diols of which
   b₁) 10 to 100 mol %, based on the total amount of diols (b), have a molecular weight of 500 to 5000 g/mol,
   b₂) 0 to 90 mol %, based on the total amount of diols (b), have a molecular weight of 60 to 500 g/mol,
c) non-(a) and non-(b) monomers containing at least one isocyanate group or at least one group reactive toward isocyanate groups, and further carrying at least one hydrophilic or potentially hydrophilic group to make the polyurethanes dispersible in water,
d) if appropriate, further, non-(a) to non-(c) polyfunctional compounds containing reactive groups selected from hydroxyl groups, mercapto groups, primary or secondary amino groups or isocyanate groups, and
e) if appropriate, non-(a) to non-(d) monofunctional compounds containing a reactive group selected from a hydroxyl group, a primary or secondary amino group or an isocyanate group.

Particular mention may be made as monomers (a) of diisocyanates X(NCO)₂, where X is an aliphatic hydrocarbon radical having 4 to 15 carbon atoms, a cycloaliphatic or aromatic hydrocarbon radical having 6 to 15 carbon atoms, or an araliphatic hydrocarbon radical having 7 to 15 carbon atoms. Examples of such diisocyanates include tetramethylene diisocyanate, hexamethylene diisocyanate (HDI), dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)-propane, trimethylhexane diisocyanate, 1,4-diisocyanatobenzene, 2,4-diisocyanatotoluene, 2,6-diisocyanatotoluene, 4,4′-diisocyanato-diphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI) such as the trans/trans, the cis/cis, and the cis/trans isomers, and mixtures of these compounds.

Diisocyanates of this kind are available commercially.

Particularly important mixtures of these isocyanates are the mixtures of the respective structural isomers of diisocyanatotoluene and diisocyanatodiphenylmethane; the mixture of 80 mol % 2,4-diisocyanatotoluene and 20 mol % 2,6-diisocyanatotoluene is particularly suitable. Also of particular advantage are the mixtures of aromatic isocyanates such as 2,4-diisocyanatotoluene and/or 2,6-diisocyanatotoluene with aliphatic or cycloaliphatic isocyanates such as hexamethylene diisocyanate or IPDI, in which case the preferred mixing ratio of the aliphatic to the aromatic isocyanates is from 4:1 to 1:4.

Compounds used to synthesize the polyurethanes, in addition to those mentioned above, also include isocyanates which in addition to the free isocyanate groups carry further, blocked isocyanate groups, e.g., uretdione groups.

With a view to effective film-forming and elasticity suitable diols (b) are principally relatively high molecular weight diols (b1), having a molecular weight of from about 500 to 5000, preferably from about 1000 to 3000 g/mol. The molar weight in question is the number-average molar weight Mn. Mn is obtained by determining the number of end groups (OH number).

The diols (b1) may be polyesterpolyols, which are known, for example, from Ullmanns Enzyklopadie der technischen Chemie, 4th edition, volume 19, pp. 62 to 65. It is preferred to use polyesterpolyols which are obtained by reacting dihydric alcohols with dibasic carboxylic acids. Instead of the free polycarboxylic acids it is also possible to use the corresponding polycarboxylic anhydrides or corresponding polycarboxylic esters of lower alcohols or mixtures thereof to prepare the polyesterpolyols. The polycarboxylic acids can be aliphatic, cycloaliphatic, araliphatic, aromatic or heterocyclic and can if appropriate be substituted, by halogen atoms for example, and/or unsaturated. Examples thereof include the following: suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, and dimeric fatty acids. Preferred dicarboxylic acids are those of the general formula HOOC—(CH₂)_{y}—COOH, where y is a number from 1 to 20, preferably an even number from 2 to 20, examples being succinic acid, adipic acid, sebacic acid, and dodecanedicarboxylic acid.

Examples of suitable polyhydric alcohols include ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl)cyclohexanes such as 1,4-bis(hydroxymethyl)cyclohexane, 2-methylpropane-1,3-diol, methylpentanediols, and also diethylene glycol, triethylene glycol, tetraethylene glycol, polyethylene glycol, dipropylene glycol, polypropylene glycol, and dibutylene glycol and polybutylene glycols. Preferred alcohols are those of the general formula HO—(CH₂)ₙ—OH, where x is a number from 1 to 20, preferably an even number from 2 to 20. Examples of such alcohols include ethylene glycol, butane-1,4-diol, hexane-1,6-diol, octane-1,8-diol, and dodecane-1,12-diol. Preference is also given to neopentyl glycol.

Suitability is also possessed by polycarbonatediols, such as may be obtained, for example, by reacting phosgene with an excess of the low molecular weight alcohols specified as synthesis components for the polyesterpolyols.

It may also be possible, if appropriate, to use lactone-based polyesterdiols, which are homopolymers or copolymers of lactones, preferably hydroxy-terminated adducts of lactones with suitable difunctional starter molecules. Preferred lactones are those derived from compounds of the general formula HO—(CH₂)ₙ—COOH where z is a number from 1 to 20 and where one hydrogen atom of a methylene unit may also be substituted by a C₁ to C₄ alkyl radical. Examples are ε-caprolactone, β-propiolactone, γ-butyrolactone and/or methyl-ε-caprolactone, and mixtures thereof. Examples of suitable starter components are the low molecular weight dihydric alcohols specified above as a synthesis component for the polyesterpolyols. The corresponding polymers of ε-caprolactone are particularly preferred. Lower polyesterdiols or polyetherdiols as well can be used as starters for preparing the lactone polymers. Instead of the polymers of lactones it is also possible to use the corresponding chemically equivalent polycondensates of the hydroxycarboxylic acids corresponding to the lactones.

Preference is given to aliphatic polyesterdiols based on alkanedicarboxylic acids and alkanediols.

Further suitable diols (b1) are polyetherdiols. They are obtainable in particular by polymerizing ethylene oxide, propylene oxide, butylene oxide, tetrahydrofuran, styrene oxide or epichlorohydrin with itself, in the presence of BF₃ for example, or by subjecting these compounds, if appropriate in a mixture or in succession, to addition reaction with starter components containing reactive hydrogen atoms, such as alcohols or amines, examples being water, ethylene glycol, propane-1,2-diol, propane-1,3-diol, 2,2-bis(4-hydroxyphenyl)propane, and aniline. Particular preference is given to polypropylene oxide, polytetrahydrofuran with a molecular weight of from 240 to 5000, and in particular of from 500 to 4500.

Compounds assumed under b₁) include only those polyetherdiols composed to an extent of less than 20% by weight of ethylene oxide. Polyetherdiols with at least 20% by weight are hydrophilic polyetherdiols, which are counted as monomers c).

It may also be possible, if appropriate, to use polyhydroxyolefins, preferably those having 2 terminal hydroxyl groups, e.g., α,ω-dihydroxypolybutadiene, α,ω-dihydroxypolymethacrylic esters or α,ω-dihydroxypolyacrylic esters, as monomers (c1). Such compounds are known for example from EP-A 0 622 378. Further suitable polyols are polyacetals, polysiloxanes, and alkyd resins.

Preferably at least 50 mol %, in particular at least 90 mol %, of the diols b₁) are polyesterdiols. With particular preference polyesterdiols exclusively are used as diols b₁).

The hardness and the elasticity modulus of the polyurethanes can be increased by using as diols (b) not only the diols (b1) but also low molecular weight diols (b2) having a molecular weight of from about 60 to 500, preferably from 62 to 200 g/mol.

Monomers (b2) used are in particular the synthesis components of the short-chain alkanediols specified for preparing polyesterpolyols, preference being given to unbranched diols having 2 to 12 carbon atoms and an even number of carbon atoms, and also to pentane-1,5-diol and neopentyl glycol.

Examples of suitable diols b₂) include ethylene glycol, propane-1,2-diol, propane-1,3-diol, butane-1,3-diol, butene-1,4-diol, butyne-1,4-diol, pentane-1,5-diol, neopenty glycol, bis(hydroxymethyl)cyclohexanes such as 1,4-bis(hydroxymethyl)cyclohexane, 2-methylpropane-1,3-diol, methylpentanediols, additionally diethylene glycol, triethylene glycol, tetraethylene glycol, polyethylene glycol, dipropylene glycol, polypropylene glycol, dibutylene glycol, and polybutylene glycols. Preference is given to alcohols of the general formula HO—(CH₂)ₓ—OH, where x is a number from 1 to 20, preferably an even number from 2 to 20. Examples thereof are ethylene glycol, butane-1,4-diol, hexane-1,6-diol, octane-1,8-diol, and dodecane-1,12-diol. Preference is further given to neopentyl glycol.

The fraction of diols (b1), based on the total amount of diols (b), is preferably from 10 to 100 mol %, and the fraction of the monomers (b₂), based on the total amount of diols (b), is preferably from 0 to 90 mol %. With particular preference the ratio of the diols (b1) to the monomers (b2) is from 0.1:1 to 5:1, more preferably from 0.2:1 to 2:1.

In order to make the polyurethanes dispersible in water they comprise, as synthesis component non-(a), non-(b), and non-(d) monomers (c), which carry at least one isocyanate group or at least one group reactive toward isocyanate groups and, furthermore, at least one hydrophilic group or a group which can be converted into a hydrophilic group. In the text below; the term “hydrophilic groups or potentially hydrophilic groups” is abbreviated to “(potentially) hydrophilic groups”. The (potentially) hydrophilic groups react with isocyanates at a substantially slower rate than do the functional groups of the monomers used to synthesize the polymer main chain.

The fraction of the components having (potentially) hydrophilic groups among the total quantity of components (a), (b), (c), (d), and (e) is generally such that the molar amount of the (potentially) hydrophilic groups, based on the amount by weight of all monomers (a) to (e), is from 30 to 1000, preferably from 50 to 500, and more preferably from 80 to 300 mmol/kg.

The (potentially) hydrophilic groups can be nonionic or, preferably, (potentially) ionic hydrophilic groups.

Particularly suitable nonionic hydrophilic groups are polyethylene glycol ethers composed of preferably from 5 to 100, more preferably from 10 to 80 repeating ethylene oxide units. The amount of polyethylene oxide units is generally from 0 to 10% by weight, preferably from 0 to 6% by weight, based on the amount by weight of all monomers (a) to (e).

Preferred monomers containing nonionic hydrophilic groups are polyethylene oxide diols containing at least 20% by weight of ethylene oxide, polyethylene oxide monools, and the reaction products of a polyethylene glycol and a diisocyanate which carry a terminally etherified polyethylene glycol radical. Diisocyanates of this kind and processes for preparing them are specified in U.S. Pat. No. 3,905,929 and U.S. Pat. No. 3,920,598.

Ionic hydrophilic groups are, in particular, anionic groups such as the sulfonate, the carboxylate, and the phosphate group in the form of their alkali metal salts or ammonium salts, and also cationic groups such as ammonium groups, especially protonated tertiary amino groups or quaternary ammonium groups.

Potentially ionic hydrophilic groups are, in particular, those which can be converted into the abovementioned ionic hydrophilic groups by simple neutralization, hydrolysis or quaternization reactions, in other words, for example, carboxylic acid groups or tertiary amino groups.

(Potentially) ionic monomers (c) are described at length in, for example, Ullmanns Enzyklopadie der technischen Chemie, 4th edition, volume 19, pp. 311-313 and in, for example, DE-A 14 95 745.

Of particular practical importance as (potentially) cationic monomers (c) are, in particular, monomers containing tertiary amino groups, examples being tris(hydroxyalkyl)amines, N,N′-bis(hydroxyalkyl)alkylamines, N-hydroxyalkyldialkylamines, tris(aminoalkyl)amines, N,N′-bis(aminoalkyl)alkylamines, and N-aminoalkyldialkylamines, the alkyl radicals and alkanediyl units of these tertiary amines consisting independently of one another of 1 to 6 carbon atoms. Also suitable are polyethers containing tertiary nitrogen atoms and preferably two terminal hydroxyl groups, such as are obtainable in a conventional manner, for example, by alkoxylating amines containing two hydrogen atoms attached to amine nitrogen, such as methylamine, aniline or N,N′-dimethylhydrazine. Polyethers of this kind generally have a molar weight of between 500 and 6000 g/mol.

These tertiary amines are converted into the ammonium salts either with acids, preferably strong mineral acids such as phosphoric acid, sulfuric acid, hydrohalic acids, or strong organic acids, or by reaction with suitable quaternizing agents such as C₁ to C₆ alkyl halides or benzyl halides, e.g., bromides or chlorides.

Suitable monomers having (potentially) anionic groups normally include aliphatic, cycloaliphatic, araliphatic or aromatic carboxylic acids and sulfonic acids which carry at least one alcoholic hydroxyl group or at least one primary or secondary amino group. Preference is given to dihydroxyalkylcarboxylic acids, especially those having 3 to 10 carbon atoms, such as are also described in U.S. Pat. No. 3,412,054. Particular preference is given to compounds of the general formula (c₁)

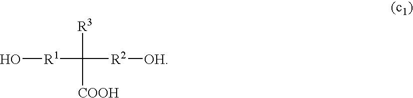

in which R¹ and R² are a C₁ to C₄ alkanediyl (unit) and R³ is a C₁ to C₄ alkyl (unit), and especially dimethylolpropionic acid (DMPA).

Also suitable are corresponding dihydroxysulfonic acids and dihydroxyphosphonic acids such as 2,3-dihydroxypropanephosphonic acid.

Otherwise suitable are dihydroxyl compounds having a molecular weight of more than 500 to 10 000 g/mol and at least 2 carboxylate groups, which are known from DE-A 39 11 827. They are obtainable by reacting dihydroxyl compounds with tetracarboxylic dianhydrides such as pyromellitic dianhydride or cyclopentanetetracarboxylic dianhydride in a molar ratio of from 2:1 to 1.05:1 in a polyaddition reaction. Particularly suitable dihydroxyl compounds are the monomers (b₂) cited as chain extenders and also the diols (b₁).

Suitable monomers (c) containing amino groups reactive toward isocyanates include aminocarboxylic acids such as lysine, β-alanine or the adducts of aliphatic diprimary diamines with α,β-unsaturated carboxylic or sulfonic acids that are specified in DE-A 20 34 479.

Such compounds obey, for example, the formula (c₂)

H₂N—R⁴—NH—R⁵—X (c₂)

where
—R⁴ and R⁵ independently of one another are a C₁ to C₆ alkanediyl unit, preferably ethylene
and X is COOH or SO₃H.

Particularly preferred compounds of the formula (c₂) are N-(2-aminoethyl)-2-aminoethanecarboxylic acid and also N-(2-aminoethyl)-2-aminoethanesulfonic acid and the corresponding alkali metal salts, with Na being a particularly preferred counterion.

Also particularly preferred are the adducts of the abovementioned aliphatic diprimary diamines with 2-acrylamido-2-methylpropanesulfonic acid, as described for example in DE-B 19 54 090.

Where monomers with potentially ionic groups are used their conversion into the ionic form may take place before, during or, preferably, after the isocyanate polyaddition, since the ionic monomers are frequently difficult to dissolve in the reaction mixture.

Particularly preferred monomers c) are monomers containing a carboxylate group or, with very particular preference, containing a sulfonate group. The sulfonate or carboxylate groups may, for example, be present in the form of their salts with an alkali metal ion or ammonium ion, or other base, as counterion.

With particular preference, sulfonate group or carboxylate group is neutralized with a base which is volatile at application temperatures (up to 200° C.), in particular with an amino base.

The monomers (d), which are different from the monomers (a) to (c) and which may if appropriate also be part of the polyurethane, serve generally for crosslinking or chain extension. They generally comprise nonphenolic alcohols with a functionality of more than 2, amines having 2 or more primary and/or secondary amino groups, and compounds which as well as one or more alcoholic hydroxyl groups carry one or more primary and/or secondary amino groups.

Alcohols having a functionality of more than 2, which may be used in order to set a certain degree of branching or crosslinking, include for example trimethylolpropane, glycerol, or sugars.

Also suitable are monoalcohols which as well as the hydroxyl group carry a further isocyanate-reactive group, such as monoalcohols having one or more primary and/or secondary amino groups, monoethanolamine for example.

Polyamines having 2 or more primary and/or secondary amino groups are used especially when the chain extension and/or crosslinking is to take place in the presence of water, since amines generally react more quickly than alcohols or water with isocyanates. This is frequently necessary when the desire is for aqueous dispersions of crosslinked polyurethanes or polyurethanes having a high molar weight. In such cases the approach taken is to prepare prepolymers with isocyanate groups, to disperse them rapidly in water, and then to subject them to chain extension or crosslinking by adding compounds having two or more isocyanate-reactive amino groups.

Amines suitable for this purpose are generally polyfunctional amines of the molar weight range from 32 to 500 g/mol, preferably from 60 to 300 g/mol, which contain at least two amino groups selected from the group consisting of primary and secondary amino groups. Examples of such amines are diamines such as diaminoethane, diaminopropanes, diaminobutanes, diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or triamines such as diethylenetriamine or 1,8-diamino-4-aminomethyloctane.

The amines can also be used in blocked form, e.g., in the form of the corresponding ketimines (see for example CA-A 1 129 128), ketazines (cf. e.g. U.S. Pat. No. 4,269,748) or amine salts (see U.S. Pat. No. 4,292,226). Oxazolidines as well, as used for example in U.S. Pat. No. 4,192,937, represent blocked polyamines which can be used for the preparation of the polyurethanes of the invention, for chain extension of the prepolymers. Where blocked polyamines of this kind are used they are generally mixed with the prepolymers in the absence of water and this mixture is then mixed with the dispersion water or with a portion of the dispersion water, so that the corresponding polyamines are liberated by hydrolysis.

It is preferred to use mixtures of diamines and triamines, more preferably mixtures of isophoronediamine (IPDA) and diethylenetriamine (DETA).

The polyurethanes comprise preferably from 1 to 30 mol %, more preferably from 4 to 25 mol %, based on the total amount of components (b) and (d), of a polyamine having at least 2 isocyanate-reactive amino groups as monomer (d).

For the same purpose it is also possible to use, as monomers (d), isocyanates having a functionality of more than two. Examples of standard commercial compounds are the isocyanurate or the biuret of hexamethylene diisocyanate.

Monomers (e), which are used, if appropriate, are monoisocyanates, monoalcohols, and mono-primary and -secondary amines. Their fraction is generally not more than 10 mol %, based on the total molar amount of the monomers. These monofunctional compounds customarily carry further functional groups such as olefinic groups or carbonyl groups and serve to introduce into the polyurethane functional groups which facilitate the dispersing and/or the crosslinking or further polymer-analogous reaction of the polyurethane. Monomers suitable for this purpose include those such as isopropenyl-α,α-dimethylbenzyl isocyanate (TMI) and esters of acrylic or methacrylic acid such as hydroxyethyl acrylate or hydroxyethyl methacrylate.

Coatings having a particularly good profile of properties are obtained in particular when the monomers (a) used are essentially only aliphatic diisocyanates, cycloaliphatic diisocyanates or araliphatic diisocyanates.

This monomer combination is supplemented in outstanding fashion as component (c) by alkali metal salts of diaminosulfonic acids; very particularly by N-(2-aminoethyl)-2-aminoethanesulfonic acid and its corresponding alkali metal salts, the Na salt being the most suitable, and also by a DETA/IPDA mixture as component (d).

The alkoxysilane compounds are, in particular, synthesis components d) or e), preferably e); carbodiimide compounds, if attached to the polyurethane, preferably come under the definition of component a).

Within the field of polyurethane chemistry it is general knowledge how the molecular weight of polyurethanes can be adjusted by selecting the proportions of the mutually reactive monomers and also the arithmetic mean of the number of reactive functional groups per molecule.

Components (a) to (e) and their respective molar amounts are normally chosen so that the ratio A: B, where
A is the molar amount of isocyanate groups and
B is the sum of the molar amount of the hydroxyl groups and the molar amount of the functional groups which are able to react with isocyanates in an addition reaction,
   is from 0.5:1 to 2:1, preferably from 0.8:1 to 1.5, more preferably from 0.9:1 to 1.2:1. With very particular preference the ratio A:B is as close as possible to 1:1.

The monomers (a) to (e) employed carry on average usually from 1.5 to 2.5, preferably from 1.9 to 2.1, more preferably 2.0 isocyanate groups and/or functional groups which are able to react with isocyanates in an addition reaction.

The polyaddition of components (a) to (e) for preparing the polyurethane takes place at reaction temperatures of up to 180° C., preferably up to 150° C., under atmospheric pressure or under the autogenous pressure.

The preparation of polyurethanes, and of aqueous polyurethane dispersions, is known to the skilled worker.

The adhesive of the invention preferably comprises further reactive groups which are able to enter into a crosslinking reaction with one another or with the carbodiimide groups. These are, in particular, acid groups, examples being carboxyl groups or sulfonic acid groups. In one particular embodiment the sulfonate or carboxylate groups needed for dispersion (see above, monomers c)) are present in the form of salts of volatile bases. Suitable examples include alkylamino compounds or, in particular, hydroxyalkylamino compounds such as triisopropanolamine. At the temperature of use (up to 200° C.) the bases then escape, producing carboxyl groups or sulfonic acid groups for the crosslinking reaction.

Carboxyl groups are also formed by transesterification reactions, so that even without the initial presence of carboxyl groups in the polyurethane a crosslinking occurs.

The adhesive of the invention is preferably an aqueous adhesive.

The adhesive may be composed solely of the polyurethane and, if appropriate, the carbodiimide (if not attached to the polyurethane) or else may comprise further additives, examples being further binders, fillers, thickeners, wetting assistants, defoamers, and crosslinkers. Further additives can be added easily to the polyurethane or to the aqueous polyurethane dispersion.

A major constituent of the adhesive is the polyurethane binder. The adhesive is composed preferably of at least 10%, more preferably of at least 20%, and very preferably at least 30% by weight of the polyurethane, based on the solids content, (i.e., without water or other solvents liquid at 21° C. and 1 bar).

Suitable further binders which may be used in the mixture with the polyurethane include, in particular, free-radically polymerized polymers, preferably in the form of their aqueous dispersions.

Polymers of this kind are composed preferably of at least 60% by weight of what are called principal monomers, selected from

C1 to C20 alkyl (meth)acrylates, vinyl esters of carboxylic acids comprising up to 20 carbon atoms, vinylaromatics having up to 20 carbon atoms, ethylenically unsaturated nitrites, vinyl halides, vinyl ethers of alcohols comprising 1 to 10 carbon atoms, aliphatic hydrocarbons having 2 to 8 carbon atoms and one or two double bonds, or mixtures of these monomers. Polymers deserving particular mention are those synthesized from more than 60% by weight of C1-C20 alkyl (meth)acrylates (polyacrylates for short) or those composed of more than 60% by weight, including up to 100 for example, of vinyl esters, especially vinyl acetate and ethylene (vinyl acetate/ethylene copolymer).

The solids content (all constituents besides water or other solvents liquid at 21° C. and 1 bar) is preferably between 20% and 80% by weight.

The adhesive of the invention may be used as a one-component (1K) or two-component (2K) adhesive. In the case of a 2K adhesive it is necessary to add a further additive prior to use, generally a crosslinker (e.g., an isocyanate compound or aziridine compound). In the case of a 1K adhesive this is not necessary; the 1K adhesive is stable on storage and already comprises the necessary crosslinkers or requires no crosslinkers or no further crosslinkers.

The adhesive of the invention is particularly suitable as a 1K adhesive.

The adhesive of the invention is especially suitable as a laminating adhesive, i.e., for the permanent adhesive bonding of extensive substrates. The extensive substrates (substrates of large surface area) are selected in particular from polymer films, paper, metal foils or wood veneer, nonwoven webs of natural or synthetic fibers; they are bonded to one another or to other moldings, e.g., moldings of wood or plastic.

Particular preference is given to polymer films, e.g., films of polyester, such as polyethylene terephthalate, polyolefins such as polyethylene, polypropylene or polyvinyl chloride, of polyacetate. Particular preference is given to foamed PVC films and foamed thermoplastic polyolefin (TPO) films.

The moldings or substrate to be bonded may have been pretreated; for example, they may have been coated with adhesion promoters.

The moldings can also be moldings which are constructed from synthetic or natural fibers or chips; moldings of plastic, ABS for example, are especially suitable. The moldings may have any desired form.

The coating of the substrates or moldings with the can take place in accordance with typical application methods. Coating is followed by drying, preferably at room temperature or temperatures up to 80° C., in order to remove water or other solvents.

The amount of adhesive applied is preferably 0.5 to 100 g/m², more preferably 2 to 80 g/m², very preferably 10 to 70 g/m².

Preference is given to unilateral coating of either the molding or the film, though coating of both of the substrates to be bonded (bilateral coating) is also appropriate.

When using 1K adhesives it is possible for the adhesive-coated substrate or molding to be stored; flexible substrates, for example, can be wound up into rolls. The coated substrate or molding is stable on storage, i.e., even after a number of weeks of storage time, the coated substrate can be processed, with the same good results.

When using a 2K adhesive it is possible to adopt a corresponding procedure, but preferably the molding is coated and not the film; after a short storage time (a few hours) the film ought to be laminated on.

For the purpose of adhesive bonding, the parts to be bonded are joined. The adhesive is then activated thermally. The temperature within the adhesive layer is preferably 20 to 200° C., more preferably 30 to 180° C.

Adhesive bonding takes place preferably under pressure, for which the parts to be bonded may be compressed with a pressure of 0.005 to 5 N/mm², for example.

The assemblies obtained are distinguished by high mechanical strength even at elevated temperatures (heat stability) or under sharply altering climatic conditions (climatic stability).

The process of the invention has particular significance in the automotive, furniture or shoe industry, such as for the bonding of flexible substrates to interior automotive components, such as dashboards, inner door linings, and parcel shelves, or for producing foil-coated furniture or for bonding shoe parts to one another.

### EXAMPLES

### Silane Compound

H₂N—CH₂—NH—CH₂—CH₂—CH₂Si—(OCH₃)³, available as Geniosil GF 91 from Goldschmidt. 3-Aminopropyltrimethoxysilane, available as Dynasilan AMMO from Degussa.

### Inventive Example 1

### With Silane and Carbodiimide Carbodiimide:Silane Molar Ratio 1:1

745 g (0.30 mol) of a polyester with an OH number of 45.2 (based on butanediol/adipic acid), 13.4 g (0.10 mol) of dimethylolpropionic acid, 1.0 g of tetrabutyl orthotitanate (10% form), and 100 g of acetone are introduced as an initial charge, admixed at 60° C. with 112.3 g (0.505 mol) of isophorone diisocyanate, and stirred at 90° C. for 4 hours. Then, in succession, 900 g of acetone, 20.25 g of triisopropanolamine (0.09 mol), 5 g of carbodiimide (polymer based on 1,3-bis(1-isocyanato-1-methylethyl)benzene, isocyanate end groups) (in 5 g of acetone) (0.005 mol), 0.97 g of aminopropyltrimethoxysilane (0.005 mol), 31.35 g of aminoethylaminoethanesulfonic acid Na salt (0.075 mol), and 40 g of water are metered in and the reaction mixture is stirred for a further 20 minutes. It is dispersed with 1300 g of water; afterward the acetone is distilled off under reduced pressure and the solids content is adjusted to approximately 40%.

### Analytical Data:

| | |
|---|---|
| Solids content: | 43.3% |
| LT: | 91.9 |
| Visc.: | 169 mPas |
| pH: | 8.1 |
| K value: | 94.5 |

### Inventive Example 2

### Similar to Example 1, but No Triisopropanolamine as Neutralizing Base

745 g (0.30 mol) of a polyester with an OH number of 45.2 (based on butanediol/adipic acid), 13.4 g (0.10 mol) of dimethylolpropionic acid, 1.0 g of tetrabutyl orthotitanate (10% form), and 100 g of acetone are introduced as an initial charge, admixed at 60° C. with 112.3 g (0.505 mol) of isophorone diisocyanate, and stirred at 90° C. for 4 hours. Then, in succession, 900 g of acetone, 5 g of carbodiimide (polymer based on 1,3-bis(1-isocyanato-1-methylethyl)benzene) (in 5 g of acetone) (0.005 mol), 44 g of aminoethylaminoethanesulfonic acid Na salt (0.105 mol), 0.97 g of aminopropyltrimethoxysilane (0.005 mol), and 40 g of water are metered in and the reaction mixture is stirred for a further 5 minutes. It is dispersed with 1300 g of water; afterward the acetone is distilled off under reduced pressure and the solids content is adjusted to approximately 40%.

### Analytical Data:

| | |
|---|---|
| Solids content: | 39.4% |
| LT: | 91.2 |
| Visc.: | 84.8 mPas |
| pH: | 6.8 |

### Inventive Example 3

### With Monoaminosilane (Incorporation as Terminal Group in the Polyurethane)

745 g (0.30 mol) of a polyester with an OH number of 45.2 (based on butanediol/adipic acid), 13.4 g (0.10 mol) of dimethylolpropionic acid, 1.0 g of tetrabutyl orthotitanate (10% form), and 100 g of acetone are introduced as an initial charge, admixed at 60° C. with 112.3 g (0.505 mol) of isophorone diisocyanate, and stirred at 90° C. for 4 hours. Then, in succession, 900 g of acetone, 20.25 g of triisopropanolamine (85% strength) (0.09 mol), 5 g of carbodiimide (polymer based on 1,3-bis(1-isocyanato-1-methylethyl)benzene) (in 5 g of acetone) (0.005 mol), 26.82 g of aminoethylaminoethanesulfonic acid Na salt (0.064 mol), 2.87 g of Dynasylan AMMO (0.016 mol), and 40 g of water are metered in and the reaction mixture is stirred for a further 5 minutes. It is dispersed with 1300 g of water; afterward the acetone is distilled off under reduced pressure and the solids content is adjusted to approximately 40%.

### Analytical Data:

| | |
|---|---|
| Solids content: | 42.7% |
| LT: | 97.2 |
| Visc.: | 87.2 mPas |
| pH: | 7.0 |

### Comparative Example 1

### Without Carbodiimide

745 g (0.30 mol) of a polyester with an OH number of 45.2 (based on butanediol/adipic acid), 13.4 g (0.10 mol) of dimethylolpropionic acid, 1.0 g of tetrabutyl orthotitanate (10% form), and 100 g of acetone are introduced as an initial charge, admixed at 60° C. with 112.3 g (0.505 mol) of isophorone diisocyanate, and stirred at 90° C. for 4 hours. Then, in succession, 900 g of acetone, 20.25 g of triisopropanolamine (85% strength) (0.09 mol), 1.94 g of aminopropyltrimethoxysilane (0.01 mol), 23.33 g of aminoethylaminoethanesulfonic acid Na salt (0.07 mol), and 40 g of water are metered in and the reaction mixture is stirred for a further 5 minutes. It is dispersed with 1300 g of water; afterward the acetone is distilled off under reduced pressure and the solids content is adjusted to approximately 40%.

### Analytical Data:

| | |
|---|---|
| Solids content: | 42.7% |
| Visc.: | 112 mPas |
| pH: | 6.85 |
| K value: | 59.5 |

### Comparative Example 2

### Without Silane Compound

745 g (0.30 mol) of a polyester with an OH number of 45.2 (based on butanediol/adipic acid), 13.4 g (0.10 mol) of dimethylolpropionic acid, 1.0 g of tetrabutyl orthotitanate (10% form), and 100 g of acetone are introduced as an initial charge, admixed at 60° C. with 112.3 g (0.505 mol) of isophorone diisocyanate, and stirred at 90° C. for 4 hours. Then, in succession, 900 g of acetone, 20.25 g of triisopropanolamine (85% strength) (0.09 mol), 10 g of carbodiimide (polymer based on 1,3-bis(1-isocyanato-1-methylethyl)benzene) (in 5 g of acetone) (0.01 mol), 29.33 g of aminoethylaminoethanesulfonic acid Na salt (0.07 mol), and 40 g of water are metered in and the reaction mixture is stirred for a further 5 minutes. It is dispersed with 1300 g of water; afterward the acetone is distilled off under reduced pressure and the solids content is adjusted to approximately 40%.

### Analytical Data:

| | |
|---|---|
| Solids content: | 42.5% |
| LT: | |
| Visc.: | 12.6mPas |
| pH: | 6.8 |

### Performance Testing:

The heat stability is determined by determining the peel strength of an assembly composed of a PVC film (strip of width 5 cm) and an ABS molding at 100° C.

For this test the polyurethane dispersions of the inventive and comparative examples were mixed with a dispersion of a vinyl acetate/ethylene copolymer in a weight ratio of 1:1 (solids) and the mixture is applied by spraying to the ABS molding and dried (coat thickness 80 g/m2 (dry)). Lamination to the PVC film was carried out in a press for 20 seconds at a temperature of 90° C. (pressure 0.8 kp/cm²)

After 5 days of storage at room temperature the peel strength was determined at 100° C.

| Polyurethane from | Peel strength at 100° C. |
|---|---|
| Inventive Example 1 | 25 N/5 cm |
| Inventive Example 2 | 26 N/5 cm |
| Inventive Example 3 | 21 N/5 cm |
| Comparative Example 1 | 18 N/5 cm |
| Comparative Example 2 | 14 N/5 cm |

1. An adhesive comprising:
a polyurethane, and
0.0001 to 0.1 mol of carbodiimide groups per 100 g of polyurethane, wherein the polyurethane contains 0.0001 to 0.1 mol of hydroxysilane or alkoxysilane groups per 100 g of polyurethane.

2. The adhesive according to claim 1, wherein said hydroxysilane or alkoxysilane groups are groups of the formula I 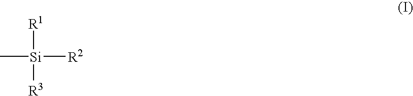
where at least one of the radicals R¹ to R³ is an alkoxy group or hydroxyl group and the remaining radicals are each an alkoxy group, hydroxyl group or alkyl group.

3. The adhesive according to claim 1, wherein the hydroxysilane or alkoxysilane groups are attached to the polyurethane as a result of a reaction between synthesis components of the polyurethane with a compound comprising hydroxysilane or alkoxysilane groups.

4. The adhesive according to claim 3, wherein the compound has been incorporated as a chain extender in the polyurethane, i.e., wherein the compound comprises at least two reactive groups which are reacted with other synthesis components of the polyurethane.

5. The adhesive according to claim 3, wherein the compound comprises at least two isocyanate-reactive amino groups.

6. The adhesive according to claim 3, wherein the compound comprises two primary amino groups, two secondary amino groups, or one primary and one secondary amino group.

7. The adhesive according to claim 1, wherein the polyurethane comprises compounds comprising carbodiimide groups as synthesis components or the adhesive comprises carbodiimide compounds as an additive.

8. The adhesive according to claim 7, wherein the carbodiimide compounds comprise on average 2 to 10 carbodiimide groups per molecule.

9. The adhesive according to claim 7, wherein the carbodiimide compound is a carbodiimide based on tetramethylxylylene diisocyanate.

10. The adhesive according to claim 1, wherein more than 50 mol % of all of the carbodiimide groups present in the adhesive are attached to the polyurethane.

11. The adhesive according to claim 1, wherein the polyurethane is synthesized from at least 60% by weight of diisocyanates, polyetherdiols, polyesterdiols, or a combination thereof.

12. The adhesive according to claim 1, wherein the polyurethane is in a dispersion in water and the adhesive thus constitutes an aqueous poly-urethane dispersion.

13. The adhesive according to claim 1, wherein the polyurethane comprises anionic groups.

14. The adhesive according to claim 1, wherein the polyurethane has a melting point in the range from −50 to 150° C.

15. The adhesive according to claim 1, which comprises at least 60% by weight of the polyurethane, based on the solids content.

16. A method for laminating a substrate comprising applying an adhesive according to claim 1 to said substrate as a one-component (1 K) adhesive.

17. A method for laminating a substrate comprising applying an adhesive according to claim 1 as a laminating adhesive, i.e., for the permanent adhesive bonding of extensive substrates.

18. The method according to claim 17, wherein extensive substrates selected from the group consisting of a polymer film, paper, a metal foil, wood veneer, and a nonwoven web of natural or synthetic fibers, are bonded to one another or to other moldings, e.g., moldings of wood or plastic.

19. A laminated molding obtained through the process according to claim 16.

20. The adhesive according to claim 1, wherein the polyurethane has a melting point in the range from 0 to 100° C.

21. The adhesive according to claim 1, wherein the polyurethane comprises sulfonate groups or carboxylate groups.
